(19) United States
(12) Patent Application Publication
(10) Pub. No.: US 2025/0124378 A1
(43) Pub. Date: Apr. 17, 2025

(54) SYSTEM AND METHOD FOR GENERATING PICK-WALKS BASED ON BATCH PICKING

(71) Applicant: Walmart Apollo, LLC, Bentonville, AR (US)

(72) Inventors: Shuyan Li, McKinney, TX (US); David Bradley, Bentonville, AR (US)

(21) Appl. No.: 18/485,629

(22) Filed: Oct. 12, 2023

(51) Int. Cl. G06Q 10/0631; G06Q 10/047; G06Q 10/087

(52) U.S. Cl. CPC G06Q 10/06315; G06Q 10/047; G06Q 10/087

(57) ABSTRACT

A system and method for generating pick-walk data from batch picking is provided. The method includes generating a vector for each item in a store, with the vector being generated based on walking distances in time from a zone corresponding to the item to other zones in the facility, walking distances in time from the item to other items within the zone corresponding to the item, a category corresponding to the item, and a subcategory corresponding to the item. Items within an online order are partitioned into clusters with each cluster including items in close proximity to one another. Pick-walks are assigned to a plurality of pickers based on the clusters, witch each pick-walk including items from a plurality of different orders.

### BACKGROUND

Order fulfillment encompasses an entire process from an initial inquiry at a point of sale to an actual delivery of an item or product to the customer. When considering a physical retail setting, in-store fulfillment pertains to a process triggered by a customer notification, such as placing an order online for either in-store pickup or delivery. This process involves various tasks, including locating the item within the store's inventory, transporting the item to the point of sale, and ensuring that there is adequate staff available to complete the sale when the customer arrives. The term used to complete some or all of these tasks is referred to as a “pick-walk”. A pick-walk is a systematic process used in order fulfillment. It involves an employee receiving a customer order and to physically move through store aisles to select and gather items (or “pick” them) to fulfill the customer order.

Current in-store picking procedures batch orders based on their priority, considering factors like due time and when the order was placed. These batched orders are subject to fixed limitations, like a maximum number of orders that can be handled in one pick-walk by the store's employee(s). These batched orders are limited by time of day and are known in advance. A staff member, often referred to as a “picker,” is assigned to fulfill a customer's entire order within the batch orders and then navigates through the retail store to retrieve the items for the entire customer's order, placing them into a tote according to a first-come-first-served basis.

However, the time taken for actual picking depends on the picker's experience with the store layout, pick-walk contents, and route.

### SUMMARY

The disclosed examples are described in detail below with reference to the accompanying drawing figures listed below. The following summary is provided to illustrate examples or implementations disclosed herein. It is not meant, however, to limit all examples to any particular configuration or sequence of operations.

Some examples provide a method for batch picking generation and optimization. The method includes receiving an order of a plurality of items from a customer; for each item of the plurality of items: accessing, from a memory, a vector that corresponds to the item, the vector comprising location information for the item, the location information comprising: walking distances in time from a zone corresponding to the item to other zones in the facility, walking distances in time from the item to other items within the zone corresponding to the item, a category corresponding to the item, and a subcategory corresponding to the item; and comparing the vector that corresponds to the item to vectors that correspond to each of the other of the plurality of items; based on the comparing, determining relative distances in time from each of the plurality of items to each of the other of the plurality of items; based on the determining, partitioning the plurality of items into a plurality of clusters, each cluster of the plurality of clusters comprising items with least relative distances in time between the items; assigning a first portion of items in a first cluster of the plurality of clusters to a first pick-walk; assigning a second portion of items in a second cluster of the plurality of clusters to a second pick-walk; and transmitting, via a network, a list of the first portion of items and the second portion of items to a user interface, wherein the first pick-walk is executed according to the first portion of items and the second pick-walk is executed according to the assigning.

Other examples provide a system for batch picking generation and optimization. The system includes a processor; a database; computer-readable media having stored thereon computer-executable instructions causing the processor to perform the following operations: receiving an order of a plurality of items from a customer; for each item of the plurality of items: accessing, from the database, a vector that corresponds to the item, the vector comprising location information for the item, the location information comprising: walking distances in time from a zone corresponding to the item to other zones in the facility, walking distances in time from the item to other items within the zone corresponding to the item, a category corresponding to the item, and a subcategory corresponding to the item; and comparing the vector that corresponds to the item to vectors that correspond to each of the other of the plurality of items; based on the comparing, determining relative distances in time from each of the plurality of items to each of the other of the plurality of items; based on the determining, partitioning the plurality of items into a plurality of clusters, each cluster of the plurality of clusters comprising items with least relative distances in time between the items; assigning a first portion of items in a first cluster of the plurality of clusters to a first pick-walk; assigning a second portion of items in a second cluster of the plurality of clusters to a second pick-walk; and transmitting, via a network, a list of the first portion of items and the second portion of items to a user interface, wherein the first pick-walk is executed according to the first portion of items and the second pick-walk is executed according to the second portion of items.

Other examples provide one or more computer-readable storage media having computer-executable instructions for batch picking generation and optimization. The instructions, when executed by a processor, cause the processor to perform the following operations: receiving an order of a plurality of items from a customer; for each item of the plurality of items: accessing, from a memory, a vector that corresponds to the item, the vector comprising location information for the item, the location information comprising: walking distances in time from a zone corresponding to the item to other zones in the facility, walking distances in time from the item to other items within the zone corresponding to the item, a category corresponding to the item, and a subcategory corresponding to the item; and comparing the vector that corresponds to the item to vectors that correspond to each of the other of the plurality of items; based on the comparing, determining relative distances in time from each of the plurality of items to each of the other of the plurality of items; based on the determining, partitioning the plurality of items into a plurality of clusters, each cluster of the plurality of clusters comprising items with least relative distances in time between the items; assigning a first portion of items in a first cluster of the plurality of clusters to a first pick-walk; assigning a second portion of items in a second cluster of the plurality of clusters to a second pick-walk; transmitting, via a network, a list of the first portion of items and the second portion of items to a user interface, wherein the first pick-walk is executed according to the first portion of items and the second pick-walk is executed according to the assigning.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an exemplary a block diagram illustrating a system for generating pick-walks based on batch picking;

FIG. 2 is an exemplary flow chart illustrating operations for generating vector representations of items based on location data;

FIG. 3 is an exemplary flow chart illustrating operations for generating pick-walks based on batch picking;

FIG. 4 is a block diagram of an example computing device for implementing examples of the present disclosure.

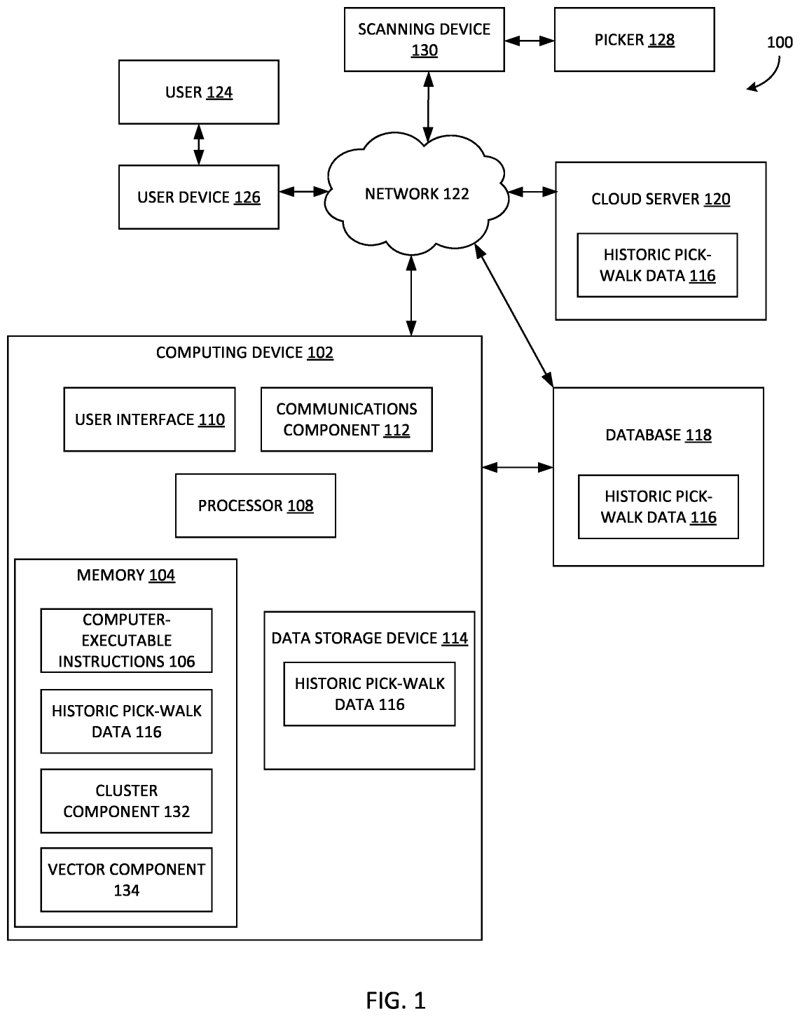

Corresponding reference characters indicate corresponding parts throughout the drawings. In FIGS. 1 to 4, the systems are illustrated as schematic drawings. The drawings may not be to scale.

### DETAILED DESCRIPTION

The various examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all implementations.

The foregoing summary, as well as the following detailed description of certain will be better understood when read in conjunction with the appended drawings. As used herein, an element or step recited in the singular and preceded by the word “a” or “an” should be understood as not necessarily excluding the plural of the elements or steps. Further, references to an implementation or an example are not intended to be interpreted as excluding the existence of additional examples that also incorporate the recited features. Moreover, unless explicitly stated to the contrary, examples “comprising” or “having” an element or a plurality of elements having a particular property could include additional elements not having that property.

Fast completion of pick-walks is important for pickup services to meet customer expectations. Conventionally, the time taken for actual picking of the items for a customer's entire order depends on the associate's experience with the store layout, contents of the order for the pick-walk (e.g., size and location of the items within the order), and a route taken by the associate. Conventionally, to optimize pick-walk completion time, there are two approaches: generating pick-walks based on physical constraints and optimizing the pick-walk route. Prior solutions to optimizing the route include traveling salesman, minimum spanning trees, and reinforcement learning algorithms. However, for these models, there is a pre-requisite to gather an exact travel distance/time between each pair of locations to visit before running each of the algorithms.

Further, obtaining precise travel distance or time between locations is challenging for in-store pickup of items located in the store due to limitations of item location data at the shelf or 2D level. Although item locations at a shelf level as well as 2D location like longitude/latitude are potentially available, they are not suitable to be directly utilized to get precise travel distance measured in time due to two limitations. First, stores contain shelves that separate lanes/aisles, thus closeness in 2D location does not necessarily translate into a short walking time if the items are in adjacent lanes/aisles. Secondly, locations at a shelf or 2D level show relative layout information, but actual walking distance/time may differ across different stores depending on a size of the store or whether the store is crowded.

The systems and methods described herein address the technical problems posed by conventional online order fulfillment. That is, the present disclosure provides systems and methods that provide a clustering model that utilizes a vectorized representation of each item in a store to facilitate assigning close/similar items together in a pick-walk and to more accurately estimate a travel time between items (for a pick-walk) at a store level. The input of this model comprises recent actual pick-walk data (e.g., pick-walk data from a previous time frame, such as the past three months) from historic pick-walk data. The historic pick-walk data includes timestamps of items that were scanned (e.g., by a mobile computing device, such as the scanning device 130) as they were picked during an actual pick-walk. The outputs of this model (e.g., location information, such as a distance in time between items/shelves/zones) are the building blocks for route optimization problems, batch-picking problems, as well as other task prioritization problems where walking time is a determining factor. Advantageously, this model is able to acquire more accurate travel time between any two pair of items at the store level, which can be critical to route optimization problems or any problem where efficiency is essential. Further, this model does not require all possible pairs of items to be actually picked next to each other or one right after the other in the historic pick-walk data in order to determine a walking distance in time for the pair of items.

Knowing the travel time between any pair of items in a store enables the clustering component to place items from a plurality of online orders into clusters, with each cluster including items that are nearest to each other, enabling similar items to be clustered together. After placing each item in a cluster, buckets are created to include order-lines to fit in a pick-walk, enabling a consolidation of similar items from multiple orders into a single pick-walk. This approach minimizes the total number of pick-walks required to fulfill all orders. By implementing batch picking, the process is streamlined and the pick speed is optimized, resulting in reduced steps for the pickers and improved efficiency overall.

Thus, the present disclosure provides a technical solution to the technical problem of accurately determining distances between items in a store using historic pick-walk data and using the historic pick-walk data to optimize the assignment of pick-walks to fulfil customer orders. In the same manner, the present disclosure provides numerous technical effects including, but not limited to, minimizing a total number of pick-walks needed to fulfil orders, reducing a number of employees needed to fulfil orders, reducing a time a given pick-walk takes, and increasing the number of orders than can be fulfilled in a particular period of time, to name a few.

FIG. 1 is an exemplary a block diagram illustrating a system for batch picking generation and optimization. The system 100 illustrated in FIG. 1 is for illustration only. Other examples of the system 100 can be used without departing from the scope of the present disclosure.

FIG. 1 illustrates a computing device 102 that represents any device executing computer-executable instructions 106 to implement the operations and functionality associated with the computing device 102. In some examples, the computing device 102 is a server, desktop personal computer, kiosk, or tabletop device. In some examples, the computing device 102 is a mobile computing device or any other portable device. A mobile computing device can include, for example but without limitation, a mobile telephone, laptop, tablet, computing pad, netbook, gaming device, and/or portable media player. In some examples, the computing device 102 represents a group of processing units or other computing devices.

In some examples, the computing device 102 includes a memory 104, at least one processor 108, user interface 110, communications component 112, and data storage device 114. The processor 108 includes any quantity of processing units and is programmed to execute computer-executable instructions 106 stored in the memory 104. The computer-executable instructions 106 are performed by the processor 108, performed by multiple processors 108 within the computing device 102, or performed by a processor external to the computing device 102.

The memory 104 includes any quantity of media associated with or accessible by the computing device 102. In some examples, the memory 104 is internal to the computing device 102, as shown in FIG. 1. In other examples, the memory 104 is external to the computing device or both external and internal. The memory 104 can include read-only memory and/or memory wired into an analog computing device. The memory 104 stores data, such historic pick-walk data 116 and applications, such as cluster component 132 and vector component 134. The applications, when executed by the processor 108, operate to perform functionality on the computing device 102. The applications can communicate with counterpart applications or services such as web services accessible via a network 122, which, in some examples is implemented by one or more physical network components, such as, but without limitation, routers, switches, network interface cards (NICs), and other network devices. The network 122 is any type of network for enabling communications with remote computing devices, such as, but not limited to, a local area network (LAN), a subnet, a wide area network (WAN), a wireless (Wi-Fi) network, or any other type of network. In this example, the network 122 is a WAN, such as the Internet. However, in other examples, the network 122 is a local or private LAN.

In addition to the memory 104, a cloud server 120 is also provided that is enabled to store data accessible to the computing device, such as historic pick-walk data 116. The cloud server 120 is a logical server providing services to the computing device 102 or other clients, such as, but not limited to, the user device 126. The cloud server 120 is hosted and/or delivered via the network 122. In some non-limiting examples, the cloud server 120 is associated with one or more physical servers in one or more data centers. In other examples, the cloud server 120 is associated with a distributed network of servers.

Furthermore, data storage device 114 includes one or more different types of data storage devices, such as, for example, one or more rotating disks drives, one or more solid state drives (SSDs), and/or any other type of data storage device. The data storage device 114, in some non-limiting examples, includes a redundant array of independent disks (RAID) array. In other examples, the data storage device 114 includes a database. The data storage device 114 in this example is included within the computing device 102, attached to the computing device, plugged into the computing device, or otherwise associated with the computing device 102. In other examples, the data storage device 114 includes a remote data storage accessed by the computing device (e.g., the historic pick-walk data 116) via the network 122, such as a remote data storage device, a data storage in a remote data center, or a cloud storage.

As explained above, vectors (for each item in historic pick-walk data 116), which are generated by the vector component 134, are used as input into the cluster component 132 during the pick-walk generation processes. However, prior to generated vectors for each item in a store, location information for each item is determined. In the following examples, location information for each item includes the following: a walking distance in time from the item (within a particular zone) to another zone, a walking distance in time between the particular item and other items within the (same) particular zone, a category ID of the particular item, and a subcategory ID of the particular item.

In some examples, a zone is an area dedicated to specific product categories such as clothing, electronics, home goods, and the like. A zone may include a single aisle or may include several aisles within the store. Within each zone there are categories. A “category” within a zone refers to a specific type or group of items/products that are organized and displayed together within a designated area. For example, in a zone labeled “clothing”, categories within this zone may include one or more of the following categories: men's apparel, women's apparel, children's clothing, footwear, or accessories. Within each category, there are sub-categories. A “sub-category” within a category refers to a more specific grouping of items/products within the broader category. The sub-category represents a further breakdown of merchandise based on characteristics like type, style, brand, size, or other distinguishing features. For example, in the zone labeled “clothing”, and in the category “Women's Apparel” there could be several sub-categories, such as: Tops (blouses, t-shirts, sweaters), Bottoms (jeans, skirts, pants), Dresses (casual, formal, evening), Outerwear (jackets, coats, vests).

In some examples, the historic pick-walk data 116 is used to obtain the location information described above. For example, the historic pick-walk data 116 is used to determine a walking distance in time between items within a store, which is fundamental to generating pick-walks as well as optimizing the pick-walks.

For example, many stores do not have the walking distance in time between (all) pairs of items in a store, and thus this location information is not readily available. As such, this location information, for example, a walking distance in time between any two items, needs to be determined. However, determining this location information is challenging for items located in the store due to limitations of item location data at the shelf or 2D level. Although item locations at a shelf level as well as 2D location like longitude/latitude are potentially available, they are not suitable to be directly utilized to get precise travel distance measured in time due to two limitations. First, stores contain shelves that separate lanes/aisles, thus closeness in 2D location does not necessarily translate into a short walking time if the items are in adjacent lanes/aisles. Secondly, locations at a shelf or 2D level show relative layout information, but actual walking distance/time may differ across different stores depending on a size of the store or whether the store is crowded.

In the examples described herein, pick-walk data, for example, the historic pick-walk data 116, includes timestamps recording the exact pick time for each item in previous orders fulfilled via pick-walks. While a walking distance in time between two particular items in a store picked one right after the other can easily be determined from the time stamps in the historic pick-walk data 116, a walking distance in time between other items in the store that are not picked one right after the other remains unknown.

To determine a walking distance in time between two items, a walking distance between zones, categories, and subcategories is determined. A distance between zones is initially determined and these distances are weighted heavier than a distance between items in categories or subcategories. That is, a walking distance in time from one zone to another can take minutes (just in walking time) given that certain zones are on opposite sides of a store from one another. Thus, the clustering component 132 utilizes the location information from the generated vectors in order facilitate minimizing long walks between far zones, and in many cases, eliminate a need to walk between two different zones at all. As described herein, a “zone” refers to a specific area or section within a store that is designated for a particular category (or categories) of products or a specific purpose. The purpose of zoning is to organize and arrange merchandise in a logical and visually appealing manner, making it easier for customers to navigate and find what they're looking for. As such, a zone consists of one or more aisles in a store. Further, while most of the same stores include the same zones, the location of these zones may be different in each store. As such, the location information determined throughout the present disclosure is store specific, as each store is different in its layout, size, and what items it offers for sale.

Examples described herein use average travel time needed to pick up different items within a same zone or in different zones from a particular time frame (e.g., a previous period of time). In some examples, the particular time frame is three months, in other examples, the particular time frame is a plurality of weeks, one week, or even days, depending on the amount of pick-walk data that can be accessed within the particular time frame. Once items in zones are identified (and labeled with the appropriate category and subcategory), the historic pick-walk data 116 can be used to identify/determine distances between each zone in store, as well as between categories and subcategories. For example, determining a walking distance in time between one item in a zone A and another item in zone B using the time stamps from one or more previous pick-walks in the historic pick-walk data 116, enables the determination of the walking distance in time between the zone A and the zone B. As such, a distance between the zone A and the zone B is known based on the fact that a walking distance in time from an item with zone A to an item is zone B is determined. This process continues to analyze walking distances in time of each item in the store (if available) in the historic pick-walk data 116 until distances between each zone in the store is determined. Table 1 shown below is an example of travel time between zones.

TABLE 1

| | | | Mean | Median | |
|---|---|---|---|---|---|
| | | | minutes | minutes | |
| | | | to next | to next | Count of |
| Zone 1 | Zone 2 | Note for Zone 2 | item | item | observations |
| FB | FB | | 0.51 | 0.32 | 1982 |
| FB | FM | | 1.02 | 0.78 | 235 |
| FB | FC | Frozen/Cooler | 1.15 | 0.95 | 292 |
| FB | FP | Produce/Fruits | 1.18 | 1.02 | 719 |
| FB | U | Household/Soda | 1.55 | 1.33 | 409 |
| FB | H | Laundry/Pet | 1.86 | 1.63 | 62 |
| FB | G | Grocery/Coffee | 2.05 | 1.65 | 220 |
| FB | FOC | Front | 2.11 | 1.64 | 170 |
| | | Center/Snacks | | | |
| FB | W | Wellness | 2.29 | 190 | 21 |

While Table 1 above illustrates walking distance time between zones, walking times between categories and between subcategories can be more difficult to extract from the historic pick-walk data 116 given that some of this information to determine an exact walking distance in time between categories and/or subcategories may not be in the historic pick-walk data 116 or at least not in the period of time extracted from the historic pick-walk data 116 (e.g., the pick-walk data for the past three months.

Thus, when exact walking distance in time between items in categories or the x-y axis for all categories is ideal is ideal, in some examples, the information needed to determine an exact walking distance in time between an item in one category to an item in the same category or another category may not be known and cannot be determined from the historic pick-walk data 116. For example, for a first item in an order, for travel time between categories, enough datapoints that cover all cases that travel between different categories may not be known. In these examples, to determine a walking distance in time, a code/ID, for example, a two-digit category number is used to demonstrate a location of an item in the particular category. For example, within a store, a category represented by the two-digit category number 80 is likely very close to a category represented by the two-digit category number 81, but far away from a category represented by the two-digit category number 20. In some examples, the code/ID for the categories are predetermined (e.g., by an administrator), are based on a location of the category, and are stored in the memory 104, the data storage device 114, the cloud server 120, and/or the database 118.

Further, while an exact walking distance in time between subcategories or the x-y axis for all subcategories is ideal, in some examples, as mentioned above, the exact walking distance in time between items in subcategories is not known and cannot be determined from the historic pick-walk data 116. For example, for a first item in an order, for travel time between subcategories, enough datapoints that cover all cases that travel between different categories may not be known. In these examples, similar to the two-digit category number, a code/ID (a two-digit subcategory number) is used to demonstrate a location of an item in a subcategory. For example, within a store, a subcategory represented by the two-digit category number 01 is likely very close to a category represented by the two-digit category number 02, but far away from a category represented by the two-digit category number 09. In some examples, the code/ID for the subcategories are predetermined (e.g., by an administrator) and stored in the memory 104, the data storage device 114, the cloud server 120, and/or the database 118.

In some examples, after the category and the subcategory are identified, the two-digit subcategory number is combined with the two-digit category number to form a four-digit number. For example, if a first item with category number 80 and subcategory number 01 has the location number 8001 (which is the combination of 80 and 01), it is known that the first item is close to a second item with location number 8002. In general, the more specific the distances with respect to the location in formation for each item are known (between Zones→between Category→between Items), the better for routing design. After the vector component 134 has generated a vector for each item in the plurality of items in a store (or at least the items that may be picked during a pick-walk), the vectors, and more specifically, the location information within the vectors, are stored in the memory 104, the data storage device 114, the cloud server 120, and/or the database 118, which is accessible by the cluster component 132 as described later herein.

When an online order is received by the computing device 102, via the communications component 112 from a user device 126 via the network 122, the order includes order information comprising: a store identification, a time in which the order is to be picked up by the customer, and a list of items within the order. In some examples, the communications component 112 includes a network interface card and/or computer-executable instructions, for example a driver, for operating the network interface card. Communication between the computing device 102 and other devices, such as but not limited to the user device 126 and/or the cloud server 120, can occur using any protocol or mechanism over any wired or wireless connection. In some examples, the communications component 112 is operable with short range communication technologies such as by using near-field communication (NFC) tags. In some examples, the communications component 112 includes a transceiver configured to transmit and receive signals, such as via the network 122.

Further, the user device 126 represents any device executing computer-executable instructions. The user device 126 can be implemented as a mobile computing device, such as, but not limited to, a wearable computing device, a mobile telephone, laptop, tablet, computing pad, netbook, gaming device, and/or any other portable device. The user device 126 includes at least one processor and a memory. The user device 126 can also include a user interface component.

In continuance with the example above in which the online order includes order information comprising: a store identification, a time in which the order is to be picked up by the customer, and a list of items within the order, each store includes time slots in which a customer (e.g., the user 124) may select to have their orders fulfilled and picked up. However, given each store has a limit of employees (e.g., pickers 128) that can fulfill/pick the orders being requested, each store has a threshold number of orders that can be fulfilled in any given time slot. The number of orders a store may fulfil at any given time slot may also depend on a size of the orders being placed. That is, orders with a high number of items causes the threshold number of orders the store is able to fulfil for a given time slot to decrease, while orders with a limited number of items enables the store to increase the threshold number of orders to fulfill for the particular timeslot. As such, a particular store may receive dozens of requests for a particular time slot, and as these orders are received, the cluster component 132 is always evaluating the size of the orders and the number of the order when partitioning items within these orders (e.g., the orders within a particular time slot) into clusters to facilitate minimized longer walk times between zones that are greater distance between one another. For example, within each Club/Date/Batch, the cluster component 132 groups close items into clusters based on their Dept_nbr, Subcat_nbr and Zone Distance. (e.g., similar items are put together). In the following examples, there are two separate algorithms that are used by the cluster component 132 to perform clustering, K-means algorithm and means-shift algorithm.

First, the K-means algorithm is used when a desired number of clusters, k is known. In the following examples, K-Means is a clustering algorithm that aims to partition n items into k clusters, where each item belongs to the cluster with the nearest mean, serving as a prototype of the cluster. The algorithm iteratively assigns each item to the nearest cluster and updates the mean of each cluster until convergence is reached. Step 1) Initialization: Randomly select k initial centroids, μ1, μ2, . . . , μk. Step 2) Assignment: Assign each item x to the closest centroid, given by the following equation: Ci=argmin ∥x−μi∥\hat{ }2 where Ci is the index of the cluster to which x belongs, and ∥.∥\hat{ }2 denotes the squared Euclidean distance. Step 3) Update: Recalculate the centroids of each cluster as the mean of physical locations of all items assigned to it, given by: μi=(1/|Si|)ΣxϵSi x where Si is the set of all data points assigned to cluster i. In one example, steps 2 and 3 are repeated until convergence is reached (i.e., no data points change cluster membership).

To reduce travel distance and improve efficiency, the K-Means clustering method is utilized to cluster items by the features listed, such as the walking distance in time required for each pair of zones, categories, and subcategories. The distance between each pair of zones is estimated for the particular store being evaluated and clusters/zones that are closer to each other are placed next to each other. Through the application of the ranked clustering method, walking distances during a pick-walk can be minimized, particularly on cross-zone walks. As a result, a 3% to 5% increase in speed is realized when compared to conventional pick-walks.

In one example, the k-means clustering algorithm is as follows:

```
1. Initialize cluster centroids μ₁, μ₂, . . . , μₖ ∈ [symbol]    ⁿ randomly.
2. Repeat until convergence: {
    $For every i , set {c}^{( i )} := arg {min}_{j} {‖ {x}^{( i )} - {μ}_{j} ‖}^{2} .$
    $For every j , set {μ}_{j} := \frac{{\sum }_{i = 1}^{m} 1 \{ {c}^{( i )} = j \} {x}^{( i )}}{{\sum }_{i = 1}^{m} 1 \{ {c}^{( i )} = j \}} .$
    }
```

In some examples, a means-shift algorithm is used when the most (close) clusters to be found is desired without knowing k (i.e., the desired number of clusters). Means-shift is a procedure for locating the maxima—the modes—of a density function given discrete data sampled from that function. [1] This is an iterative method, and an initial estimate {x} is given to start. Next, a kernel function {K(x_{i}−x)} is given. This function determines the weight of nearby points for re-estimation of the mean. Typically, a Gaussian kernel on the distance to the current estimate is used, {K (x_{i}−x)=e\hat{ }{−c∥x_{i}−x∥\hat{ }{2}}}. The weighted mean of the density in the window is determined by {K} is {m(x)={\frac{\sum_{x_{i}\in N(x)}K(x_{i}−x)x_{i}}{\sum_{x_{i}\in N(x)}K(x_{i}−x)}}} where {N(x)} is the neighborhood of {x}, a set of points for which {K (x_{i}−x)\neq 0}.

After clustering items within a plurality of orders within the given time slots, the cluster component 132 ranks the clusters of items according to their distance to other clusters within the store. Table 2 shown below illustrates a ranking of clusters of items within a particular store, wherein a batch represents the items (from one or more of the orders) within the cluster a picker 128 is going to pick for a given time slot.

TABLE 2

| | | | | Item | | Ranked |
|---|---|---|---|---|---|---|
| Store | Date | Batch | Zone | Location | Cluster | Cluster |
| Store1 | 2/2 | 1(7-8 AM) | A | 1034 | 0 | 0 |
| Store1 | 2/2 | 1(7-8 AM) | A | 1024 | 0 | 0 |
| Store1 | 2/2 | 1(7-8 AM) | A | 7423 | 2 | 1 |
| Store1 | 2/2 | 1(7-8 AM) | A | 8532 | 2 | 1 |
| Store1 | 2/2 | 1(7-8 AM) | A | 4656 | 2 | 1 |
| Store1 | 2/2 | 1(7-8 AM) | A | 4783 | 2 | 1 |
| Store1 | 2/2 | 1(7-8 AM) | B | 2399 | 1 | 2 |
| Store1 | 2/2 | 1(7-8 AM) | B | 2316 | 1 | 2 |
| Store1 | 2/2 | 1(7-8 AM) | B | 1038 | 2 | 3 |
| Store1 | 2/2 | 1(7-8 AM) | B | 1032 | 2 | 3 |
| Store1 | 2/2 | 1(7-8 AM) | C | 9472 | 2 | 3 |
| Store1 | 2/2 | 1(7-8 AM) | C | 9873 | 2 | 3 |
| Store1 | 2/2 | 1(7-8 AM) | C | 4686 | 2 | 3 |
| Store1 | 2/2 | 2(8-9 AM) | . . . | . . . | . . . | . . . |
| Store1 | 2/2 | 3(9-10 AM) | . . . | . . . | . . . | . . . |
| Store1 | 2/2 | 4(8-9 AM) | . . . | . . . | . . . | . . . |

As shown in Table 2, Ranked Cluster 0 and Ranked Cluster 1 are closest clusters, and then Ranked Cluster 2 is the next closest cluster to Ranked Cluster 2. (Similar item clusters are put together). By using the route optimizing method, a walking distance in time needed to fulfill orders is decreased, by about 3.3% when compared to conventional pick-walks and a pick speed using this algorithm increases upon current pick speed (single order picking and/or baseline batch picking) by 3% to 5% (0.6 labor hour reduction per store/per day; 131 k hours saved per year across all stores within the company). The clustering component 132, when used in curbside batch picking, not only reduces labor hours, but also has the following benefits: 1) it allows the stores to increase customer experience by completing picking task faster without being overdue; and 2) it enables stores to increase the maximum orders to take according to higher pick speed and to increase and potential sales. Additionally, the algorithm's route optimization can be generalized for use in other store routing related tasks as well, for example, providing pick-walk list for customers, assisting task prioritization for in-store employees by taking into account distance to different tasks.

In some examples, a First Fit algorithm, which is a heuristic method used to solve the bin-packing problem is used to optimize the number of items a particular picker 128 can “pick” during a given pick-walk. That is, the First Fit algorithm enables the picker 128 to pack a set of items into a minimum number of fixed-size containers. In this example, the containers are the pick-walks, and the First Fit algorithm iteratively places each item in the first pick-walk that has enough remaining space to accommodate it. If no such pick-walk exists, a new pick-walk is created.

In one example, to increase the number of units picked within the given physical constraints, a bucketing approach is employed to group items based on physical factors such as temperature band and tote fitness. The first fit algorithm is utilized to exhaustively search among the order-lines within each bucket to fit into a particular pick-walk. In one example, the pseudocode for the first fit algorithm is as follows: Initialize an empty list of pick-walks and set the threshold for each pick-walk to, for example, no more than 30 unique items and 9 unique orders. While thresholds are provided herein as upper limits for the number items and/or the number of orders that may be included in any given pick-walk, the thresholds may be higher or lower than the examples given herein.

With continued reference to the First Fit algorithm, for each item to be packed, iterates through the list of pick-walks and 1) places the item in a first pick-walk that has enough remaining space to accommodate it; and if no such bin exists, 2) creates a new pick-walk and place the item in it. In one example, steps 1 and 2 are repeated for all items until all items are allocated into pick-walks and the number of bins used is output.

By implementing the First Fit algorithm, physical space utilization is optimized within each pick-walk, leading to a 3% reduction in the total number of generated pick-walks. This improvement results in a reduction of the fixed cost associated with starting or ending pick-walks, which typically takes at least two minutes of “prep-time” per pick-walk.

In one example, each generated pick-walk is presented to a picker 128 via the user interface 110. In some examples, the user interface 110 includes a graphics card for displaying data to a user (e.g., the picker 128), and receiving data from the picker 128. The user interface 110 can also include computer-executable instructions, for example a driver, for operating the graphics card. The user interface 110 can further include a display, for example a touch screen display or natural user interface, and/or computer-executable instructions, for example a driver, for operating the display. The user interface 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

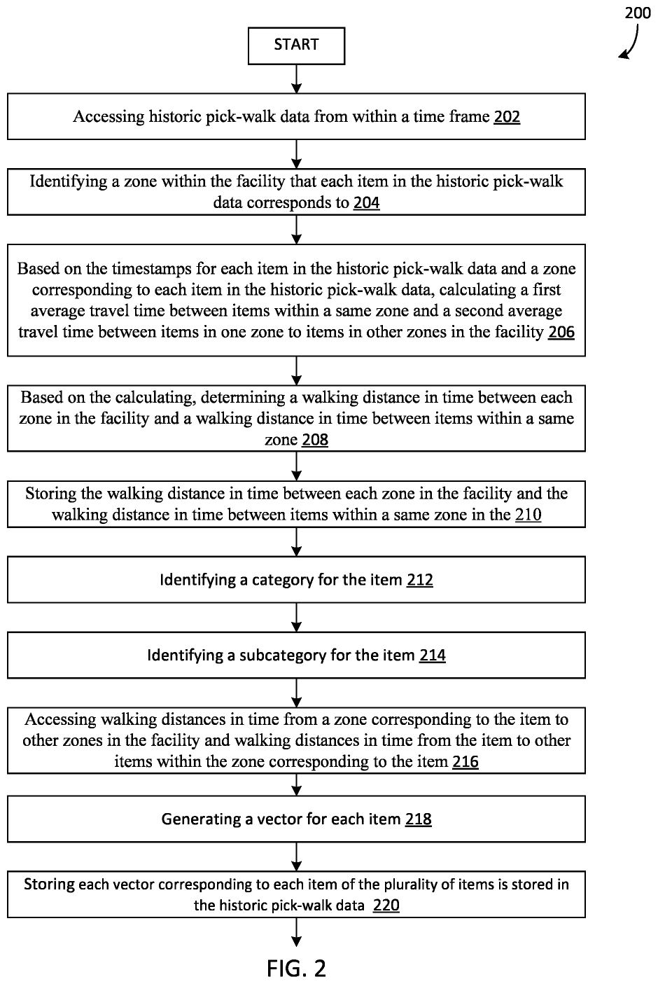

With reference now to FIG. 2, an exemplary flow chart illustrating operation of a computing device 102 to calculate a vector representation for each of a plurality of items in a store is provided. The method 200 can be implemented by one or more elements of the system 100, such as the computing device 102 and the vector component 134. The method 200 is provided for illustration only. Other examples of the method 200 can be used without departing from the scope of the present disclosure.

The method 200 begins by accessing, at 202, by the computing device 102, the historic pick-walk data 116 for each of the plurality of items within a particular store. In one example, the historic pick-walk data 116 is accessed for every item in the store, and in other examples, only the items within the store that are part of an online order are accessed. The historic pick-walk data 116 is accessed to identify the location information for each item. In some examples, the location information for each item includes the following: walking distances in time from a zone corresponding to the item to other zones in the store/facility, walking distances in time from the item to other items within the zone corresponding to the item, a category corresponding to the item, and a subcategory corresponding to the item.

In one example, the pick-walk data from the historic pick-walk data 116 is accessed for a particular time frame, for example, a previous three-month window of time. The pick-walk data within the historic pick-walk data 116 includes timestamps that record an exact pick time for each item in a previous pick-walk that was performed within the particular time frame. At 204, a zone within the store/facility that each of the plurality of items corresponds to is identified. At 206, based on the timestamps for each item of the plurality of items in the historic pick-walk data and a zone corresponding to each of the plurality of items, an average travel time (e.g., a walking distance in time) between a particular items and each other item within a same zone is calculated and an average travel time between the particular item in a particular zone to other zones in the store/facility is calculated. At 208, based on the calculating, the walking distance in time between each zone in the store/facility and the walking distance in time between items within the same zone are determined. At 210, the walking distance in time between each zone in the facility and the walking distance in time between items within a same zone are stored in the memory 104, for example, in the historic pick-walk data 116.

At 212, a category for the item is identified. The identified category is used to determine a walking distance in time between the item and items within the same category or another category. While an exact walking distance in time between categories or the x-y axis for all categories is ideal, in some examples, the walking distance in time between items in categories is not known and cannot be determined from the historic pick-walk data 116. For example, for a first item in an order enough datapoints that cover all cases that travel between different categories or items within the same category may not be known. In these examples, a code/ID, for example, a two-digit category number is used to demonstrate a location of an item. For example, within a store, a category represented by the number 80 is likely very close to a category represented by the number 81, but far away from a category represented by the number 20. In some examples, the code/ID for the categories are predetermined (e.g., by an administrator) and stored in the memory 104, the data storage device 114, a cloud server 120, and/or a database 118.

At 214, a subcategory for the item is identified. The identified subcategory is used to determine a walking distance in time between subcategories or the x-y axis for all subcategories is ideal, in some examples, the exact walking distance in time between items with a subcategory is not known and cannot be determined from the historic pick-walk data 116. For example, for a first item in an order, travel time between subcategories, enough datapoints that cover all cases that travel between different categories may not be known. In these examples, a code/ID, for example, a two-digit subcategory number is used to demonstrate a location of an item. In some examples, the code/ID for the subcategories are predetermined (e.g., by an administrator) and stored in the memory 104, the data storage device 114, the cloud server 120, and/or the database 118.

In some examples, after the category and the subcategory are identified, the two-digit subcategory number is combined with the two-digit category number to form a four-digit number. For example, if a first item with category number 80 and subcategory number 01 has the location number 8001, it is known that the first item is close to a second item with location number 8002.

At 216, the walking distances in time from a zone corresponding to each item to other zones in the store/facility and walking distances in time from the item to other items within the zone corresponding to the items is accessed from the memory 104. At 218, a vector for each item is generated based on the identified category, the identified subcategory, and the walking distances in time from the zone corresponding to the item to other zones in the facility and the walking distances in time from the item to other items within the zone corresponding to the item. At 220, each vector corresponding to each item of the plurality of items is stored in the historic pick-walk data 116, to be used by the cluster component 132 during pick-walk generation.

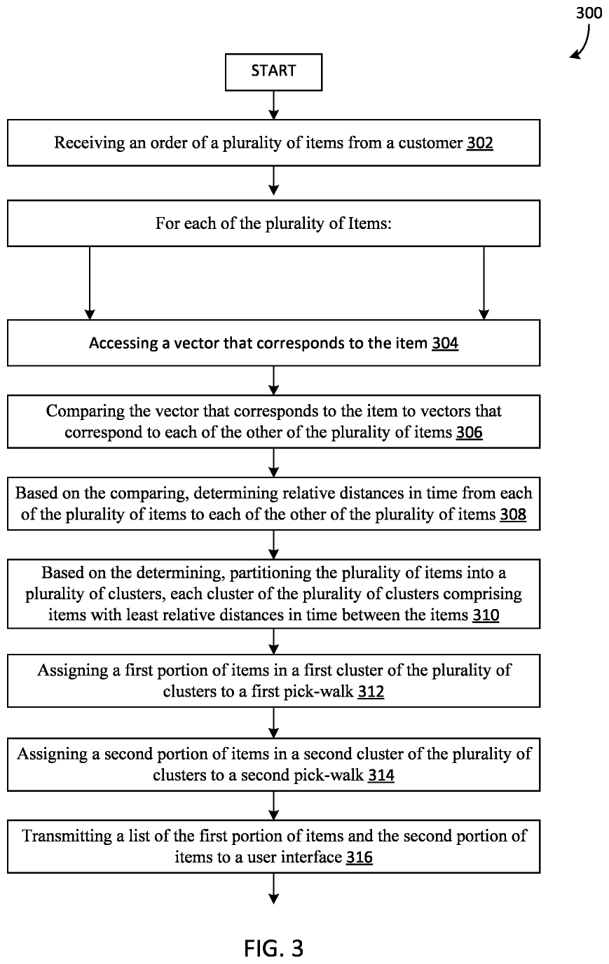

With reference now to FIG. 3, an exemplary flow chart illustrating operation of generating pick-walks based on the generated vectors is provided. The method 300 can be implemented by one or more elements of the system 100, such as the computing device 102 and cluster component 132. The method 300 is provided for illustration only. Other examples of the method 300 can be used without departing from the scope of the present disclosure.

The process beings at 302, when an order of a plurality of items is received by the computing device 102 from a user 124 (e.g., a customer) via the user device 126 over the network 122. Note: For each item of the plurality of items in the order, operations 304-316 are performed.

At 304, a vector that corresponds to the item is accessed from the memory 104, and more specifically, from the historic pick-walk data 116. In some examples, the vector includes location information for the corresponding item. In some examples, the location information includes the following: walking distances in time from a zone corresponding to the item to other zones in the facility, walking distances in time from the item to other items within the zone corresponding to the item, a category corresponding to the item, and a subcategory corresponding to the item. At 306, the vector that corresponds to the item is compared to vectors that correspond to each of the other of the plurality of items. At 308, based on the comparing, relative distances in time (e.g., walking distances in time) from each of the plurality of items to each of the other of the plurality of items are determined. At 310, based on the determining, the plurality of items is partitioned into a plurality of clusters, with each cluster of the plurality of clusters comprising items with least relative distances in time between the items. In one example, each of the plurality of clusters includes items from a plurality of orders. As such, when a cluster (or a portion of items in the cluster) are assigned to a pick-walk, the pick-walk includes items from multiple orders. However, while the pick-walk includes items from multiple orders, the pick-walk is optimized by having items that are closest to one another and the pick-walk is batched to include similar items based on a temperature in which the items are stored/kept (e.g., ambient, chilled, or frozen).

In one example, each of the plurality of items are partitioned into a cluster of the plurality of clusters with a nearest mean. In another example, partitioning the plurality of items into the plurality of clusters comprises iteratively assigning each of the plurality of items to a cluster that is nearest with respect to relative distance in time compared to other clusters of the plurality of clusters, and updating a mean based on relative distance of each of plurality of clusters until convergence is reached. In one example, each of the plurality of clusters are ranked based on distance. At 310, a first portion of items in a first cluster of the plurality of clusters is assigned to a first pick-walk. In one example, the first cluster is assigned to the first pick-walk based on a ranking of the first cluster, for example, a distance the first cluster is from a start of the pick-walk to other clusters. In another example, the first portion of items are assigned to the first pick-walk based on one or more of the following: a size of each item in the first portion, and a temperature of each item in the first portion, wherein the temperature is ambient, chilled, or frozen. Thus, items that are similar (e.g., all frozen items) are assigned to a same pick-walk. In one example, the second pick-walk is assigned a third portion of items in a third cluster of the plurality of clusters when a number of items in the second portion of items does not exceed a threshold number of items. That is, each pick-walk includes a minimum number of items and a maximum number of items to be included within the pick-walk. When the threshold number of items for a particular pick-walk has not been reached, additional items (from nearest clusters) are added to the pick-walk. At 312, a second portion of items in a second cluster of the plurality of clusters is assigned to a second pick-walk. In the examples described herein, each pick-walk (e.g., the first pick-walk and the second pick-walk) are assigned to different employees to execute (e.g., different pickers 128). At 314, a list of the first portion of items and the second portion of items are transmitted, via the network 122 to the user interface 110. At 316, the first pick-walk is executed according to the first portion of items and the second pick-walk is executed according to the second portion of items and the third portion of items. In one example, the first pick-walk and the second pick-walk are executed simultaneously. In the above examples, each pick-walk is picking items from various online orders. Thus, when each picker 128 returns from the pick-walk with each item the picker 128 is required to pick, the picker 128 places these items in a bin, where the items are consolidated with respect to the online order in which they were placed under.

### Exemplary Operating Environment

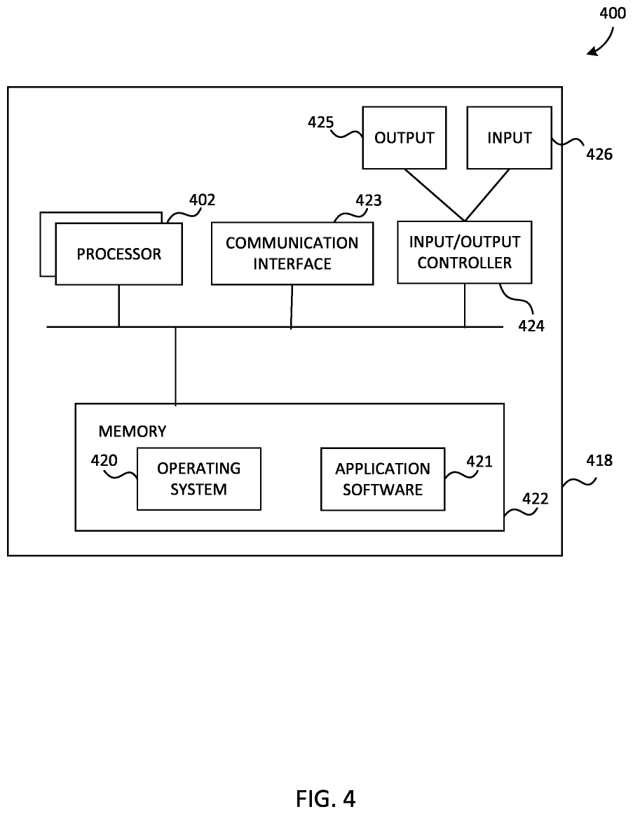

The present disclosure is operable with a computing apparatus according to an example as a functional block diagram 400 in FIG. 4. In an example, components of a computing apparatus 418 may be implemented as a part of an electronic device according to one or more examples described in this specification. For example, the computing apparatus 418 comprises one or more processors 402 which may be microprocessors, controllers, or any other suitable type of processors for processing computer executable instructions to control the operation of the electronic device. Alternatively, or in addition, the processor 402 is any technology capable of executing logic or instructions, such as a hardcoded machine. Platform software comprising an operating system 420 or any other suitable platform software may be provided on the apparatus 418 to enable application software 421 to be executed on the device.

Computer executable instructions may be provided using any computer-readable media that is accessible by the computing apparatus 418. Computer-readable media may include, for example, computer storage media such as a memory 422 and communications media. Computer storage media, such as a memory 422, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 422) is shown within the computing apparatus 418, it will be appreciated by a person skilled in the art, that the storage may be distributed or located remotely and accessed via a network or other communication link (e.g., using a communication interface 423).

In some examples, the computer-readable media includes instructions that, when executed by the processor 402, execute the operations shown in FIGS. 2 and 3.

The computing apparatus 418 may comprise an input/output controller 424 configured to output information to one or more output devices 425, for example a display or a speaker, which may be separate from or integral to the electronic device. For example, the output device 425 can be a user interface. The input/output controller 424 may also be configured to receive and process an input from one or more input devices 426, for example, a keyboard, a microphone, or a touchpad. In some examples, the one or more input devices 426 is an input reception module. In one example, the output device 425 may also act as the input device. An example of such a device may be a touch sensitive display that functions as both the input/output controller 424. The input/output controller 424 may also output data to devices other than the output device, e.g., a locally connected printing device. In some examples, a user may provide input to the input device(s) 426 and/or receive output from the output device(s) 425.

The functionality described herein can be performed, at least in part, by one or more hardware logic components. According to an example, the computing apparatus 418 is configured by the program code when executed by the processor 402 to execute the examples of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUS).

At least a portion of the functionality of the various elements in the figures may be performed by other elements in the figures, or an entity (e.g., processor, web service, server, application program, computing device, etc.) not shown in the figures.

Although described in connection with an example computing device, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing g systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

In examples involving a general-purpose computer, aspects of the disclosure transform the general-purpose computer into a special-purpose computing device when configured to execute the instructions described herein.

An example computer-implemented method for generating pick-walks based on batch picking includes receiving an order of a plurality of items from a customer; for each item of the plurality of items: accessing, from a memory, a vector that corresponds to the item, the vector comprising location information for the item, the location information comprising: walking distances in time from a zone corresponding to the item to other zones in the facility, walking distances in time from the item to other items within the zone corresponding to the item, a category corresponding to the item, and a subcategory corresponding to the item; and comparing the vector that corresponds to the item to vectors that correspond to each of the other of the plurality of items; based on the comparing, determining relative distances in time from each of the plurality of items to each of the other of the plurality of items; based on the determining, partitioning the plurality of items into a plurality of clusters, each cluster of the plurality of clusters comprising items with least relative distances in time between the items; assigning a first portion of items in a first cluster of the plurality of clusters to a first pick-walk; assigning a second portion of items in a second cluster of the plurality of clusters to a second pick-walk; and transmitting, via a network, a list of the first portion of items and the second portion of items to a user interface, wherein the first pick-walk is executed according to the first portion of items and the second pick-walk is executed according to the assigning.

An example system for a generating pick-walks based on batch picking includes a processor, a database, and computer-readable media having stored thereon computer-executable instructions causing the processor to perform the following operations: receiving an order of a plurality of items from a customer; for each item of the plurality of items: accessing, from the database, a vector that corresponds to the item, the vector comprising location information for the item, the location information comprising: walking distances in time from a zone corresponding to the item to other zones in the facility, walking distances in time from the item to other items within the zone corresponding to the item, a category corresponding to the item, and a subcategory corresponding to the item; and comparing the vector that corresponds to the item to vectors that correspond to each of the other of the plurality of items; based on the comparing, determining relative distances in time from each of the plurality of items to each of the other of the plurality of items; based on the determining, partitioning the plurality of items into a plurality of clusters, each cluster of the plurality of clusters comprising items with least relative distances in time between the items; assigning a first portion of items in a first cluster of the plurality of clusters to a first pick-walk; assigning a second portion of items in a second cluster of the plurality of clusters to a second pick-walk; and transmitting, via a network, a list of the first portion of items and the second portion of items to a user interface, wherein the first pick-walk is executed according to the first portion of items and the second pick-walk is executed according to the second portion of items.

An example computer-readable media comprising computer-executable instructions for generating pick-walks based on batch picking includes is provided. The computer-executable instruction, when executed by a processor, cause the processor to perform the following operations: receiving an order of a plurality of items from a customer; for each item of the plurality of items: accessing, from the database, a vector that corresponds to the item, the vector comprising location information for the item, the location information comprising: walking distances in time from a zone corresponding to the item to other zones in the facility, walking distances in time from the item to other items within the zone corresponding to the item, a category corresponding to the item, and a subcategory corresponding to the item; and comparing the vector that corresponds to the item to vectors that correspond to each of the other of the plurality of items; based on the comparing, determining relative distances in time from each of the plurality of items to each of the other of the plurality of items; based on the determining, partitioning the plurality of items into a plurality of clusters, each cluster of the plurality of clusters comprising items with least relative distances in time between the items; assigning a first portion of items in a first cluster of the plurality of clusters to a first pick-walk; assigning a second portion of items in a second cluster of the plurality of clusters to a second pick-walk; and transmitting, via a network, a list of the first portion of items and the second portion of items to a user interface, wherein the first pick-walk is executed according to the first portion of items and the second pick-walk is executed according to the second portion of items.

Alternatively, or in addition to the other examples described herein, examples include any combination of the following:
wherein each of the plurality of items are partitioned into a cluster of the plurality of clusters with a nearest mean;
wherein partitioning the plurality of items into the plurality of clusters comprises: iteratively assigning each of the plurality of items to a cluster that is nearest with respect to relative distance in time compared to other clusters of the plurality of clusters; and ranking each cluster of the plurality of clusters based on relative distance in time to other clusters of the plurality of clusters; and
based on the ranking, assigning a third portion of items in a third cluster of the plurality of clusters to the second pick-walk when a number of items in the second portion of items does not exceed a threshold number of items;
wherein the first portion of items are assigned to the first pick-walk based on one or more of the following: a size of each item in the first portion, and a temperature of each item in the first portion, wherein the temperature is ambient, chilled, or frozen;
wherein the first pick-walk and the second pick-walk are executed by different people;
wherein assigning the first task to the first node and the second task to the second node is based at least on the resource demand of each of the first task and the second task and the resource capacity of the first node and the second node;
wherein the first portion of items in the first cluster and the second portion of items in the second cluster include items from two or more other orders;
accessing, from the memory, historic pick-walk data within a time frame, the historic pick-walk data comprising timestamps that record a pick time for each item in a pick-walk; identifying a zone within the facility that each item in the historic pick-walk data corresponds to;
based on the timestamps for each item in the historic pick-walk data and a zone corresponding to each item in the historic pick-walk data, calculating a first average travel time between items within a same zone and a second average travel time between items in one zone to items in other zones in the facility;
based on the calculating, determining a walking distance in time between each zone in the facility and a walking distance in time between items within a same zone; and storing the walking distance in time between each zone in the facility and the walking distance in time between items within a same zone in the memory;
identify a category for the item;
identify a subcategory for the item;
access, from the memory, walking distances in time from a zone corresponding to the item to other zones in the facility and walking distances in time from the item to other items within the zone corresponding to the items; and
generating a vector for the item based on the identified category, the identified subcategory, and the walking distances in time from the zone corresponding to the item to other zones in the facility and the walking distances in time from the item to other items within the zone corresponding to the item.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving an order of a plurality of items from a customer;
for each item of the plurality of items:
accessing, from a memory, a vector that corresponds to the item, the vector comprising location information for the item, the location information comprising: walking distances in time from a zone corresponding to the item to other zones in a facility, walking distances in time from the item to other items within the zone corresponding to the item, a category corresponding to the item, and a subcategory corresponding to the item; and
comparing the vector that corresponds to the item to vectors that correspond to each of the other of the plurality of items;
based on the comparing, determining relative distances in time from each of the plurality of items to each of the other of the plurality of items;
based on the determining, partitioning the plurality of items into a plurality of clusters, each cluster of the plurality of clusters comprising items with least relative distances in time between the items;
assigning a first portion of items in a first cluster of the plurality of clusters to a first pick-walk;
assigning a second portion of items in a second cluster of the plurality of clusters to a second pick-walk; and
transmitting, via a network, a list of the first portion of items and the second portion of items to a user interface, wherein the first pick-walk is executed according to the first portion of items and the second pick-walk is executed according to the assigning.

2. The method according to claim 1, wherein each of the plurality of items are partitioned into a cluster of the plurality of clusters with a nearest mean.

3. The method according to claim 1, wherein partitioning the plurality of items into the plurality of clusters comprises:
iteratively assigning each of the plurality of items to a cluster that is nearest with respect to relative distance in time compared to other clusters of the plurality of clusters; and
updating a mean based on relative distance of each of the plurality of clusters until convergence is reached.

4. The method according to claim 1, further comprising:
ranking each cluster of the plurality of clusters based on relative distance in time to other clusters of the plurality of clusters; and
based on the ranking, assigning a third portion of items in a third cluster of the plurality of clusters to the second pick-walk when a number of items in the second portion of items does not exceed a threshold number of items.

5. The method according to claim 1, wherein the first portion of items are assigned to the first pick-walk based on one or more of the following: a size of each item in the first portion, and a temperature of each item in the first portion, wherein the temperature is ambient, chilled, or frozen.

6. The method according to claim 1, wherein the first pick-walk and the second pick-walk are executed by different people.

7. The method according to claim 1, wherein the first portion of items in the first cluster and the second portion of items in the second cluster include items from two or more other orders.

8. The method according to claim 1, further comprising:
accessing, from the memory, historic pick-walk data within a time frame, the historic pick-walk data comprising timestamps that record a pick time for each item in a pick-walk;
identifying a particular zone within the facility that each item in the historic pick-walk data corresponds to;
based on the timestamps for each item in the historic pick-walk data and the particular zone corresponding to each item in the historic pick-walk data, calculating a first average travel time between items within a same zone and a second average travel time between items in one zone to items in other zones in the facility;
based on the calculating, determining a walking distance in time between each zone in the facility and a walking distance in time between items within the same zone; and
storing the walking distance in time between each zone in the facility and the walking distance in time between items within the same zone in the memory.

9. The method according to claim 8, further comprising:
for each item in the facility:
identifying the category for the item;
identifying the subcategory for the item;
accessing, from the memory, walking distances in time from the zone corresponding to the item to the other zones in the facility and walking distances in time from the item to the other items within the zone corresponding to the item; and
generating the vector for the item based on the identified category, the identified subcategory, and the walking distances in time from the zone corresponding to the item to the other zones in the facility and the walking distances in time from the item to the other items within the zone corresponding to the item.

10. A system comprising:
a processor;
a database;
computer-readable media having stored thereon computer-executable instructions causing the processor to perform the following operations:
receiving an order of a plurality of items from a customer;
for each item of the plurality of items:
accessing, from the database, a vector that corresponds to the item, the vector comprising location information for the item, the location information comprising: walking distances in time from a zone corresponding to the item to other zones in a facility, walking distances in time from the item to other items within the zone corresponding to the item, a category corresponding to the item, and a subcategory corresponding to the item; and
comparing the vector that corresponds to the item to vectors that correspond to each of the other of the plurality of items;
based on the comparing, determining relative distances in time from each of the plurality of items to each of the other of the plurality of items;
based on the determining, partitioning the plurality of items into a plurality of clusters, each cluster of the plurality of clusters comprising items with least relative distances in time between the items;
assigning a first portion of items in a first cluster of the plurality of clusters to a first pick-walk;
assigning a second portion of items in a second cluster of the plurality of clusters to a second pick-walk; and
transmitting, via a network, a list of the first portion of items and the second portion of items to a user interface, wherein the first pick-walk is executed according to the first portion of items and the second pick-walk is executed according to the second portion of items.

11. The system according to claim 10, wherein partitioning the plurality of items into the plurality of clusters comprises:
iteratively assigning each of the plurality of items to a cluster that is nearest with respect to relative distance in time compared to other clusters of the plurality of clusters; and
updating a mean based on the relative distance of each of plurality of clusters until convergence is reached.

12. The system according to claim 10, wherein the computer-executable instructions further cause the processor to perform the following operations:
ranking each cluster of the plurality of clusters based on relative distance in time to other clusters of the plurality of clusters; and
based on the ranking, assigning a third portion of items in a third cluster of the plurality of clusters to the second pick-walk when a number of items in the second portion of items does not exceed a threshold number of items.

13. The system according to claim 10, wherein the first portion of items are assigned to the first pick-walk based on one or more of the following: a size of each item in the first portion, and a temperature of each item in the first portion, wherein the temperature is ambient, chilled, or frozen; and
wherein the first portion of items in the first cluster and the second portion of items in the second cluster include items from two or more other orders.

14. The system according to claim 10, wherein the computer-executable instructions further cause the processor to perform the following operations:
accessing, from the database, historic pick-walk data within a time frame, the historic pick-walk data comprising timestamps that record, from a mobile computing device, a pick time for each item in a pick-walk;
identifying a zone within the facility that each item in the historic pick-walk data corresponds to;
based on the timestamps for each item in the historic pick-walk data and a zone corresponding to each item in the historic pick-walk data, calculating a first average travel time between items within a same zone and a second average travel time between items in one zone to items in other zones in the facility;
based on the calculating, determining a walking distance in time between each zone in the facility and a walking distance in time between items within a same zone; and
storing the walking distance in time between each zone in the facility and the walking distance in time between items within a same zone in the database.

15. The system according to claim 14, wherein the computer-executable instructions further cause the processor to perform the following operations:
for each item in the facility:
identify a category for the item;
identify a subcategory for the item;
access, from the database, walking distances in time from a zone corresponding to the item to other zones in the facility and walking distances in time from the item to other items within the zone corresponding to the items;
generating a vector corresponding to the item based on the identified category, the identified subcategory, and the walking distances in time from the zone corresponding to the item to other zones in the facility and the walking distances in time from the item to other items within the zone corresponding to the item; and
storing the generated vector corresponding to the item in the database.

16. One or more computer-readable media comprising computer-executable instructions that, when executed by a processor, cause the processor to perform the following operations:
receiving an order of a plurality of items from a customer;
for each item of the plurality of items:
accessing, from a memory, a vector that corresponds to the item, the vector comprising location information for the item, the location information comprising: walking distances in time from a zone corresponding to the item to other zones in a facility, walking distances in time from the item to other items within the zone corresponding to the item, a category corresponding to the item, and a subcategory corresponding to the item; and
comparing the vector that corresponds to the item to vectors that correspond to each of the other of the plurality of items;
based on the comparing, determining relative distances in time from each of the plurality of items to each of the other of the plurality of items;
based on the determining, partitioning the plurality of items into a plurality of clusters, each cluster of the plurality of clusters comprising items with least relative distances in time between the items;
assigning a first portion of items in a first cluster of the plurality of clusters to a first pick-walk;
assigning a second portion of items in a second cluster of the plurality of clusters to a second pick-walk; and
transmitting, via a network, a list of the first portion of items and the second portion of items to a user interface, wherein the first pick-walk is executed according to the first portion of items and the second pick-walk is executed according to the assigning.

17. The one or more computer-readable media according to claim 16, wherein partitioning the plurality of items into the plurality of clusters comprises:
iteratively assigning each of the plurality of items to a cluster that is nearest with respect to relative distance in time compared to other clusters of the plurality of clusters; and
updating a mean based on relative distance of each of the plurality of clusters until convergence is reached.

18. The one or more computer-readable media according to claim 16, wherein the computer-executable instructions further cause the processor to perform the following operations:
ranking each cluster of the plurality of clusters based on relative distance in time to other clusters of the plurality of clusters; and
based on the ranking, assigning a third portion of items in a third cluster of the plurality of clusters to the second pick-walk when a number of items in the second portion of items does not exceed a threshold number of items.

19. The one or more computer-readable media according to claim 16, wherein the first pick-walk and the second pick-walk are executed by different people; and
wherein the first portion of items in the first cluster and the second portion of items in the second cluster include items from two or more other orders.

20. The one or more computer-readable media according to claim 16, wherein the computer-executable instructions further cause the processor to perform the following operations:
for each item in the facility:
identify the category for the item;
identify the subcategory for the item;
access, from the memory, walking distances in time from a zone corresponding to the item to other zones in the facility and walking distances in time from the item to other items within the zone corresponding to the items;
generating a vector corresponding to the item based on the identified category, the identified subcategory, and the walking distances in time from the zone corresponding to the item to other zones in the facility and the walking distances in time from the item to other items within the zone corresponding to the item; and
storing the generated vector corresponding to the item in the memory.
